(19) United States
(12) Patent Application Publication
(10) Pub. No.: US 2006/0280958 A1
(43) Pub. Date: Dec. 14, 2006

(54) Emission enhancing coating, article to which the coating is applied and method for applying the coating to a surface

(76) Inventor: Petrus A Van Nijnatten, Deurne (NL)

Correspondence Address: NIXON & VANDERHYE, PC, 901 NORTH GLEBE ROAD, 11TH FLOOR, ARLINGTON, VA, 22203, US

(21) Appl. No.: 10/563,862

(22) PCT Filed: Jun. 24, 2004
(86) PCT No.: PCT/NL04/00449

§ 371 Date: May 12, 2006

(30) Foreign Application Priority Data
Jul. 10, 2003 (NL) 1023880

(51) Int. Cl. B32B 15/04

(52) U.S. Cl. 428/457; 428/469

(57) ABSTRACT

The invention relates to an emission enhancing coating for a surface, which coating comprises at least one electrically conductive transparent film and at least two non-conductive films, wherein the conductive and non-conductive films have been applied alternately on top of one another. The invention further relates to an article to which a coating according to the invention has been applied. Such an article is, for instance, a solar cell, light reflector or a metal foil. The invention further relates to a method for applying an emission enhancing coating according to the invention to a surface.

The invention relates to an emission enhancing coating, an article to which the coating is applied, and a method for applying the coating to a surface.

A common problem with articles of which the surface has a low emissivity is that the heat inside the article cannot be adequately controlled, so that the article can become too hot, which may have an adverse effect on the functioning of the article. For instance, when the article is a solar cell, the surface must not have too low an emissivity because, otherwise, as a result of the heat development in the active layer, the effectiveness of the active layer is adversely affected.

It is known that the emissivity of a surface with low emissivity can be increased by applying a coating of a non-conductive material to the surface, this coating usually being built up from multiple layers of different non-conductive materials or a single thick layer of a non-conductive material. As a result, the total thickness of such a coating is great and is of the order of magnitude of the wavelengths of the radiation to be emitted or is even greater, which complicates the use of inorganic coatings due to stress and adhesion problems with the substrate. However, these inorganic coatings are precisely the materials preferably used by a skilled person due to their good temperature, UV and gamma radiation resistance.

It has now surprisingly been found that the emissivity of a surface with a low emissivity can particularly suitably be increased by applying a thin inorganic coating to the surface, which coating is built up from at least one electrically conductive transparent film and non-conductive films which have been applied alternately on top of one another.

The invention therefore relates to an emission enhancing coating for a surface, which coating comprises at least one electrically conductive transparent film and at least two non-conductive films, with the conductive and non-conductive films having been applied alternately on top of one another.

By using the coating according to the invention, an emissivity of the surface can be obtained of more than 75 percent.

Preferably, the coating according to the invention is applied to a surface with low emissivity, for instance an emissivity lower than 25 percent.

In a suitable embodiment, the total thickness of the coating is smaller than the wavelength of the radiation to be emitted by the surface. Preferably, the total thickness of the coating is at most 100 micrometers, more preferably at most 20 micrometers, and still more preferably at most 5 micrometers.

Preferably, at least one of the two non-conductive films is transparent, and still more preferably, each of the at least two non-conductive films is transparent.

The transparent films as used in the present invention are transparent to visible light.

The coating is preferably built up from two or more electrically conductive films and two or more non-conductive films. At least one of the electrically conductive films is transparent. Preferably, two or more electrically conductive films are transparent, and still more preferably, all electrically conductive films present are transparent.

A skilled person will understand that the number of electrically conductive films and non-conductive films to be used depends on the use of the coating.

The thickness of each electrically conductive film is usually 10 nm to 200 nm, preferably 10 nm to 150 nm.

The thickness of each non-conductive film is usually 200 nm to 2000 nm, preferably 500 nm to 1500 nm.

The electrically conductive transparent film may suitably comprise one or more metals chosen from the group of gold, aluminum, copper, chrome, nickel and rhodium. Preferably, the one or more metals are chosen from the group of chrome, nickel and rhodium.

Also, the electrically conductive films may comprise one or more semiconductors chosen from the group of conductive metal oxides, conductive nitrides, germanium, silicon, zinc sulfide, zinc selenium and zinc tellurium. Preferably, the semiconductors are doped metal oxides, still more preferably tin-doped indium oxide, fluorine-doped tin oxide and aluminum-doped zinc oxide.

The non-conductive films comprise suitable non-conductive metal oxides, non-conductive fluorides, non-conductive carbides or non-conductive nitrides. Preferably, silicon oxide, titanium oxide, aluminum oxide, magnesium fluoride, barium fluoride or calcium fluoride are used. Still more preferably, the non-conductive film comprises silicon oxide.

The invention further relates to an article with a surface with a low emissivity to which a coating according to the invention has been applied.

The coating is usually applied to the article as a top layer.

In the coating according to the invention, the electrically conductive and the non-conductive films have been applied alternately on top of one another. Preferably, as a first film, a non-conductive film has been applied to the surface, still more preferably a non-conductive transparent film. However, also, a thin conductive, optionally transparent film may have been applied to the surface first, before the non-conductive films are applied.

The conductive and non-conductive films may each as such be built up from different layers of conductive and non-conductive materials, respectively.

In a suitable embodiment, the coating according to the invention is used in a solar cell. The coating may then directly be applied to the film of transparent conductive oxides. When the coating comprises glasslike materials such as silicon oxide, it will also directly function as a protective top layer for the solar cell. In a different and likewise suitable embodiment of a solar cell, a first coating according to the invention may be applied as a top layer to the film of transparent conductive oxides, while a second coating according to the invention is applied to the underside of the substrate of the solar cell.

According to the invention, the coating may be applied to articles with a surface with low emissivity. Such articles are preferably solar cells which may, for instance, be used in solar panels, light reflectors, lamps, metal foils, and articles which can be used in vacuum and space applications.

The invention therefore also relates to a solar cell, light reflector or metal foil to which a coating according to the invention has been applied.

The invention further relates to a method for applying the emission enhancing coating according to the invention to a surface with low emissivity, in which the conductive and non-conductive films have been applied alternately on top of one another to the surface. Preferably, as a first film, a non-conductive film is applied to the surface, and still more preferably a non-conductive transparent film. The films can be applied to the surface and on top of one another with methods known to a skilled person. Such methods comprise the sputtering method, the chemical vapor deposition method and the physical vapor deposition method.

### EXAMPLE

A coating according to the present invention consists of the following 5 films:

| | |
|---|---|
| Film 1: | 600 nm SiO₂ (non-conductive transparent film) |
| Film 2: | 34 nm tin-doped indium oxide (conductive transparent film) |
| Film 3: | 1360 nm SiO₂ (non-conductive transparent film) |
| Film 4: | 53 nm tin-doped indium oxide (conductive transparent film) |
| Film 5: | 1310 nm SiO₂ (non-conductive transparent film) |

The coating has a total thickness of 3357 nm, and film 1 has been applied as a first film to a solar cell with an electrically conductive 470 nm-thick ZnO top layer.

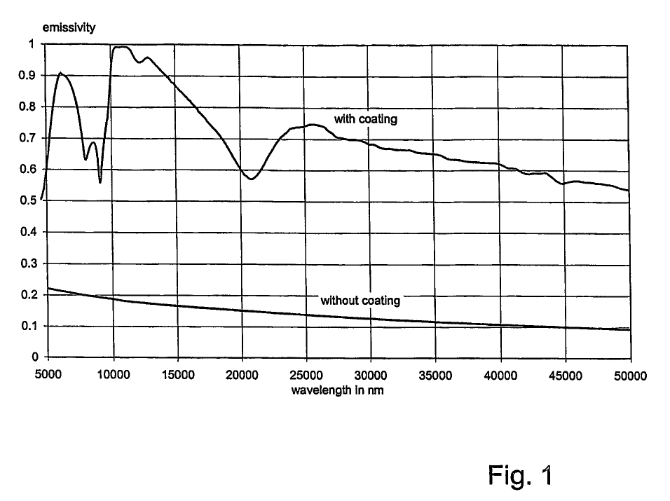

The thermal emissivity of the solar cell was measured with and without coating, while it is noted that the thermal emissivity is defined as an average value over the entire wavelength range, and the wavelength-dependent energy distribution is taken into account. The respective values of the thermal emissivity are shown in FIG. 1, which clearly shows that the thermal emissivity of the solar cell at room temperature was 17% before coating, while it increases to 79% in the presence of the coating. In other words, by using the coating according to the invention, the thermal emissivity of the solar cell became approximately five times greater.

1. An emission enhancing coating for a surface, which coating comprises at least one electrically conductive transparent film and at least two non-conductive films, wherein the conductive and non-conductive films have been applied alternately on top of one another.

2. A coating according to claim 1, wherein the total thickness of the coating is smaller than the wavelength of the radiation to be emitted by the surface.

3. A coating according to claim 1, wherein the total thickness of the coating is at most 100 micrometers.

4. A coating according to claim 3, wherein the total thickness of the coating is at most 20 micrometers.

5. A coating according to claim 4, wherein the total thickness of the coating is at most 5 micrometers.

6. A coating according to claim 1, wherein the electrically conductive film comprises a metal.

7. A coating according to claim 6, wherein the conductive film comprises a metal chosen from the group of chrome, nickel and rhodium.

8. A coating according to claim 1, wherein the electrically conductive transparent film comprises a semiconductor chosen from the group of doped metal oxides, conductive nitrides and carbides.

9. A coating according to claim 8, wherein the semiconductor is chosen from the group of, preferably, tin-doped indium oxide, fluorine-doped tin oxide and aluminum-doped zinc oxide.

10. A coating according to claim 1, wherein each of the electrically conductive and non-conductive films is transparent.

11. A coating according to claim 1, wherein the non-conductive film comprises a non-conductive material chosen from the group of non-conductive metal oxides, metal fluorides, metal carbides and metal nitrides.

12. A coating according to claim 11, wherein the non-conductive films comprise silicon oxide.

13. An article with a surface with a low emissivity to which a coating according to claim 1 has been applied.

14. An article according to claim 13, wherein, as a first film, a non-conductive transparent film has been applied to the surface.

15. A metal foil to which a coating according to claim 1 has been applied.

16. A solar cell to which a coating according to claim 1 has been applied.

17. A light reflector to which a coating according to claim 1 has been applied.

18. A method for applying an emission enhancing coating according to claim 1 to a surface, wherein the conductive and non-conductive films have been applied alternately on top of one another to the surface.

19. A method according to claim 18, wherein, as a first film, a non-conductive transparent film has been applied to the surface.
